(19) United States
(12) Patent Application Publication
(10) Pub. No.: US 2011/0236852 A1
(43) Pub. Date: Sep. 29, 2011

(54) DENTAL PASTE HOLDER

(76) Inventor: Christie Choi, Fairfax, VA (US)

(21) Appl. No.: 12/711,737

(22) Filed: Mar. 25, 2010

(51) Int. Cl. A61C 17/00

(52) U.S. Cl. 433/49

(57) ABSTRACT

A dental paste holder and kit are disclosed that include a bowl, stem, and base. The holder includes structure dimensioned to fit between fingers during use. A disposable version of the present invention includes an integral bowl, stem, and base, whereas a partially disposable version of the present invention includes an integral stem and base with a removable bowl. A linear sidewall on either the bowl or base prevents rolling of the holder when placed laterally on a substantially flat surface.

### FIELD OF THE INVENTION

The present invention relates to the field of dentistry and more specifically to the field of dental paste receptacles.

### BACKGROUND

The dental prophylactic paste is used to remove stain on teeth. There are generally two types of reservoirs to contain the said paste. One is a reusable container which a needed amount of the said paste is scooped up from it. This may be economical but exposed to high contamination to aerosols.

The other type is a standard disposable cup. It is about one-half inch in diameter that is cup-shaped and cylindrical. The top portion of the said cup is covered by sterile removable adhesive sheet. The said cup is most widely used type due to less contamination exposure to aerosols. However, the said cup is designed in such a way that results in uncomfortable and unstable positioning for a clinician.

Several devices had been designed to remedy this problem. As disclosed in U.S. Pat. No. 3,327,391 (Malm, 1967), U.S. Pat. No. 4,884,308 (Porteous, 1989), U.S. Pat. No. 5,048,731 (Moreschini, 1991), U.S. Pat. No. 5,169,315 (Bull, 1992), and U.S. Pat. No. 5,732,862 (Bull, 1998), the metal and plastic clips, rings, or ring-like devices hold receptacles. However, the previously-used devices present several disadvantages to the clinician.

Sharp edges of metal rings can end up damaging the clinician's gloves. Many devices require use of a second hand to manipulate them. Retention of the cup decreases over time. Lack of stability of the devices results in poor operation with a prophy angle. Ultimately, ergonomically unsuitable prior art results in fatiguing clinician's hand and fingers.

U.S. Pat. No. 5,996,864 (Birglechner, 1999) discloses a holder with that permits a clinician to grasp the holder and a dental instrument such as a dental mirror in one hand at the same time. However, the receptacle of the holder lacks adequate retention of the cup, which tends to slip the cup out of the receptacle prior to or during treatment. The circular base of the holder causes great instability in any position other than upright placement on flat surface, e.g. a setup tray. It tends to roll on a surface if it is positioned horizontally.

Therefore, there is a need for a paste holder that is cost-effective, disposable, capable of enhanced paste retention, and that can be easily manipulated between the fingers of a user.

### SUMMARY

The present invention is directed to a dental paste holder for inter-finger positioning. The dental past holder includes a bowl, bowl cover, a stem, and a base. The bowl has a paste cavity that retains semiviscous dental paste. The stem is an elongate structure affixed to the bottom of the bowl with a perimeter substantially less than a perimeter of the bowl. The base is substantially planar and is integrally affixed to the stem. The base includes a perimeter that is substantially greater than the stem perimeter. The base has at least one substantially linear sidewall. A removable bowl cover protects the dental paste and may be dislocated by a user. The dental paste holder components are sized to permit the stem of the holder to be clasped between fingers while the bowl and base serve as barriers to longitudinal motion of the holder.

In another embodiment of the present invention, the stem is rigid and includes an attachment member that attaches to a hole within the bottom of the bowl. This permits portions of the present invention to be reusable with a disposable bowl.

Therefore, it is an aspect of the present invention to present a paste holder that is cost-effective.

It is a further aspect of the present invention to present a paste holder that is disposable.

It is a further aspect of the present invention to present a paste holder that is capable of enhanced paste retention.

It is a further aspect of the present invention to present a paste holder that can be easily manipulated between the fingers of a user.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a perspective view of an embodiment of the holder.

FIG. 2 is an exploded, perspective view of an embodiment of the holder.

FIG. 3 is a perspective view of an embodiment of the holder.

FIG. 4 is a perspective view of an embodiment of the holder.

FIGS. 5A-C are upper, orthographic views of embodiments of the holder.

### DETAILED DESCRIPTION

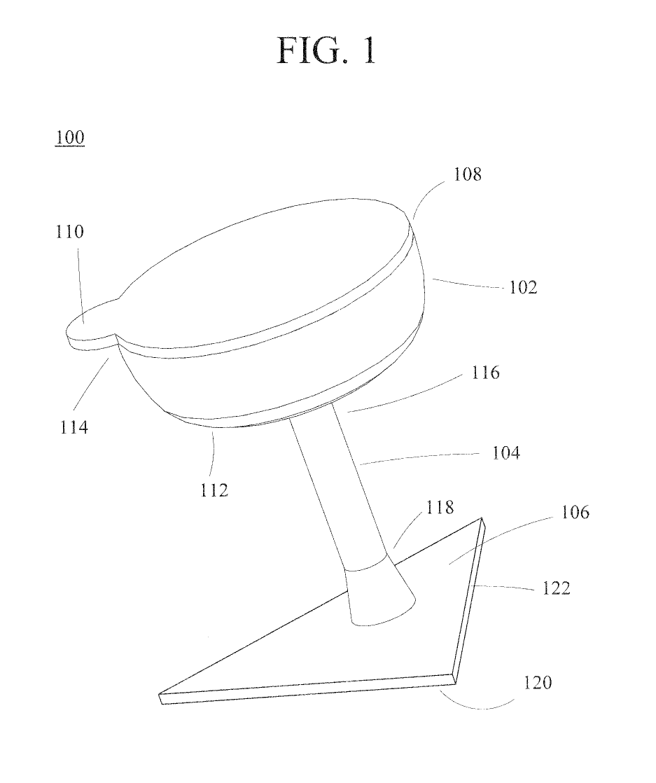

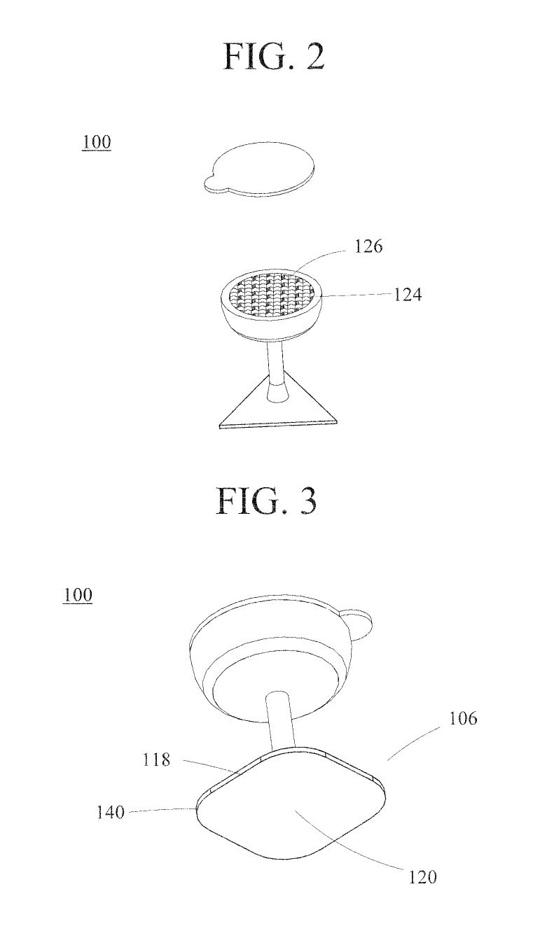

Referring first to FIGS. 1 and 2, a basic embodiment of the dental holder 100 is shown. The holder includes a bowl 102, a bowl cover 108, a stem 104, and a base 106.

The bowl 102 includes a paste cavity 124 that acts as reservoir for semiviscous dental fluids. By semiviscous, it is meant those fluids that are fluid enough to be utilized in connection with dental instruments for the purpose of oral distribution, but with a resistance to motion to refrain from dislocation from the cavity during periods of common human limb motion. Examples of semiviscous materials include dental paste 126 (and other medicaments) including polishing paste, pumice paste, and fluoride. The bowl 102 may comprise multiple shapes includes a generally hemispherical shape or a polygonal shape. As will be discussed later, it is preferred that either the bowl or the base include a polygonal shape with at least one linear side. Disposed upon the bowl's upper portion 114 is a bowl cover 108. The bowl cover 108 is preferably a sterile removable adhesive film, but may also include covers that utilize size-fitting properties, e.g. lids. A tab 110 is used with the preferred film to facilitate cover removal.

To be structurally amenable to comfortable placement within the finger of user, it is preferred that the dimensions of the bowl slope downward from the upper portion 114 to the lower portion 112 of the bowl 102. Attached to the bowl's lower portion 112 is an upper portion 116 of the stem 104. The stem 104 is an elongate structure that is certain embodiments is integrally affixed to the bowl. The stem 104 may be fabricated of any material suitable to fulfill the purposes of the present invention, and it is preferred that a pliable or rigid plastic is utilized. By integral, it is meant that two or more components unite to form a single piece that is separable only through breakage. The stem 104 includes a lower portion 118 that may gently slope towards an integral connection to the base 106.

The base 106 includes is a substantially planar component that assists to stabilize the holder 100. A substantially planar orientation is preferred in both dimension and thickness. By dimension it is meant that the base 106 abruptly present a generally flat surface adapted to contact a finger of user. By thickness, it is meant that the base have minimal girth. Of the base 106 and the bowl 102, it is preferred that one includes a linear side, and more preferred that the base 106 include a linear side. By presenting a linear face to a resting surface, e.g. a setup tray, the holder 100 when positioned on its side will be unable to roll. The base 106 includes a sidewall 122, at least one portion of which includes a linear face. By linear, it is meant that the sidewall includes a face co-planar to a degree that prevents substantial rolling of the present invention. The base 106 may include any shape, but preferably includes a polygonal shape. As FIG. 3 shows, the polygonal base 106 may include one or more rounded corners 140 to avoid presenting pointed edges to a user whose fingers are occupied in an important task and as the present invention may be positioned near sensitive body portions of user's client. The base 106 preferably includes a stand surface 120 substantially planar to a degree that permits the holder 100 to maintain an erect position when positioned upon the stand surface 120. The base 106 may utilize a more pliable plastic consistency than the stem and base to permit a user's fingers to temporarily deform the dimensions of the base 106 during use for purposes of user finger comfort.

Returning to FIG. 1, the present invention includes components sized to permit the stem 106 of the holder to be clasped between fingers while the bowl 102 and base 106 serve as barriers to longitudinal motion of the holder in the user's fingers. The sizing that permits such characteristics relates to the perimeters of the bowl, base, and stem. A bowl maximum perimeter α includes a dimension that is substantially greater than the stem central perimeter β. The stem central perimeter β is preferably substantially greater than the base maximum perimeter γ. By maximum perimeter it is meant the perimeter of that particular component at its greatest quantity. By central perimeter, it is meant the perimeter of that particular component on or about its substantial midpoint. It is further preferred that the base maximum perimeter and the bowl maximum perimeter are substantially similar to permit comfort that may derive from such similarity. Other embodiments of the present invention may utilize a base with a perimeter that is either substantially greater or smaller than the perimeter of the bowl to permit a user to scoop her finger under the holder 100 while the holder is positioned under its side.

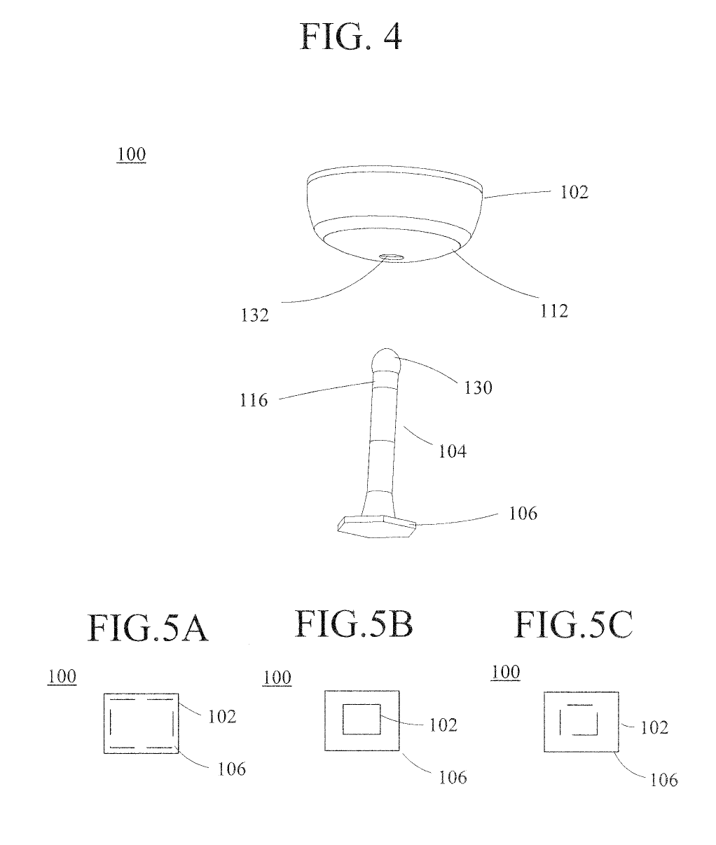

FIG. 4 depicts a partially disposable kit embodiment of the holder 100 that includes a bowl 102 that is removably attached to the upper portion 116 of the stem 104 via a stem attachment member 130. Rather than a completely integrated holder, the partially disposable holder includes a separation between the bowl 102 and an integral stem/base complex with the attachment member distally located from the base 106. The attachment member 130 preferably utilizes size-fitting characteristics to achieve a temporary union with a port 132 located on the lower portion 112 of the bowl 102. The stem 104 may be inserted into the bowl 102 for temporary use of the bowl. The bowl may be removed and then replaced with a new bowl with different or fresher paste.

As FIGS. 5A-5C show, the bowl 102 may utilize a polygonal shape that is similar to the polygonal shape of the base 106. The polygonal dimensions may be substantially similar or substantially dissimilar. It is preferred that when the base and the bowl have similar shapes, that those shapes present a similar, or even identical, orientation to achieve maximum stability when occupying a sidewise position.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A dental paste holder for inter-finger positioning, said holder comprising:
a bowl with a bowl maximum perimeter and defining a paste cavity;
a semiviscous dental paste directly disposed within said paste cavity;
a stem, centrally integrally affixed to said bowl, having a stem central perimeter substantially less than said bowl maximum perimeter;
a substantially planar base, integrally affixed to said stem, having a base maximum perimeter substantially greater than said stem central perimeter, and with at least one substantially linear base sidewall; and
a bowl cover, removably affixed to said bowl, dimensioned to house said paste cavity,
wherein said base maximum perimeter, said stem central perimeter, and said bowl maximum perimeter are dimensionally related to permit inter-finger positioning about said stem with said bowl and said base as barriers to longitudinal motion.

2. The holder of claim 1 wherein said base is pliable.

3. The holder of claim 1 wherein said base maximum perimeter is substantially equal to said bowl maximum perimeter.

4. The holder of claim 3 wherein said base includes a polygon shape.

5. The holder of claim 4 wherein said base includes a polygon shape with at least one rounded corner.

6. The holder of claim 5 wherein said base polygon shape consists of rounded corners.

7. The holder of claim 1 wherein said bowl maximum perimeter is substantially greater than said base maximum perimeter.

8. The holder of claim 1 wherein said base maximum perimeter is substantially greater than said bowl maximum perimeter.

9. The holder of claim 1 wherein said base and said bowl share a co-planar, linear sidewall.

10. The holder of claim 9 wherein said base and said bowl are identical polygon shapes with identical orientations.

11. A dental paste holder for inter-finger positioning, said holder comprising:
a bowl with a bowl maximum perimeter and defining a paste cavity;
a semiviscous dental paste directly disposed within said paste cavity;
a stem, centrally integrally affixed to said bowl, having a stem central perimeter substantially less than said bowl maximum perimeter;
a substantially planar, pliable, and polygonal base, integrally affixed to said stem, having a base maximum perimeter substantially greater than said stem central perimeter; and
a bowl cover, removably affixed to said bowl, dimensioned to house said paste cavity,
wherein said base maximum perimeter, said stem central perimeter, and said bowl maximum perimeter are dimensionally related to permit inter-finger positioning about said stem with said bowl and said base as barriers to longitudinal motion.

12. The holder of claim 11 wherein said base maximum perimeter is substantially equal to said bowl maximum perimeter.

13. The holder of claim 12 wherein said base includes at least one rounded corner.

14. The holder of claim 13 wherein said base polygon shape consists of rounded corners.

15. The holder of claim 11 wherein said bowl maximum perimeter is substantially greater than said base maximum perimeter.

16. The holder of claim 11 wherein said base maximum perimeter is substantially greater than said bowl maximum perimeter.

17. A dental paste holder kit for inter-finger positioning, said holder comprising:
a bowl with a bowl maximum perimeter, bowl affixation port, and defining a paste cavity;
a semiviscous dental paste directly disposed within said paste cavity;
a rigid stem, adapted to removalby affix to said bowl affixation port, having a stem central perimeter substantially less than said bowl maximum perimeter and an attachment member longitudinally located thereon;
a substantially planar base, integrally and distally affixed to said stem, having a base maximum perimeter substantially greater than said stem central perimeter, and with at least one substantially linear base sidewall; and
a bowl cover, removably affixed to said bowl, dimensioned to house said paste cavity,
wherein said base maximum perimeter, said stem central perimeter, and said bowl maximum perimeter are dimensionally related when joined to permit inter-finger positioning about said stem with said bowl and said base as barriers to longitudinal motion.

18. The kit of claim 17 wherein said base is pliable.

19. The kit of claim 18 wherein said base maximum perimeter is substantially equal to said bowl maximum perimeter.

20. The kit of claim 19 wherein said base includes a polygon shape.
